(19) United States
(12) Patent Application Publication
(10) Pub. No.: US 2013/0081159 A1
(43) Pub. Date: Mar. 28, 2013

(54) ADVANCED ATOMIC FORCE MICROSCOPY SCANNING FOR OBTAINING A TRUE SHAPE

(71) Applicants: Huiwen Liu, Eden Prairie, MN (US); Peter Gunderson, Ellsworth, WI (US); Lin Zhou, Eagan, MN (US)

(72) Inventors: Huiwen Liu, Eden Prairie, MN (US); Peter Gunderson, Ellsworth, WI (US); Lin Zhou, Eagan, MN (US)

(73) Assignee: SEAGATE TECHNOLOGY LLC, Cupertino, CA (US)

(21) Appl. No.: 13/559,034

(22) Filed: Jul. 26, 2012

Related U.S. Application Data
(60) Provisional application No. 61/513,440, filed on Jul. 29, 2011.
(60) Provisional application No. 61/521,746, filed on Aug. 9, 2011.

(51) Int. Cl. G01Q 60/24

(52) U.S. Cl. CPC G01Q 60/24
USPC 850/33

(57) ABSTRACT

Advanced atomic force microscopy (AFM) methods and apparatuses are presented. An embodiment may comprise performing a first scan at a first angle, a second scan at a second angle, and correcting a system drift error in the first scan based on the second scan. Another embodiment may comprise performing a global scan of a first area, a local scan of a second area within the first area, correcting a leveling error in the local scan based on the global scan, and outputting a corrected sample image. Another embodiment may comprise performing a first scan at a first position at a first angle, a second scan at a flat region using the same scan angle and scan size to correct a scanner runout error in the first scan based on the second scan.

### CROSS REFERENCE TO RELATED APPLICATIONS

The present application claims priority to pending U.S. provisional patent applications Ser. No. 61/513,440, filed Jul. 29, 2011, entitled “Advanced Atomic Force Microscopy Scanning;” and Ser. No. 61/521,746, filed Aug. 9, 2011, entitled “Advanced Atomic Force Microscopy Scanning for Obtaining a True Shape,” the contents of which are hereby incorporated by reference in their entirety.

### BACKGROUND

The present disclosure is generally related to systems, tools, software, control, and methods for scanning probe microscope techniques, especially atomic force microscopy techniques and systems.

### SUMMARY

Methods and apparatuses for improved Advanced atomic force microscopy (AFM) scanning may comprise one or more of: performing a first scan at a first angle, a second scan at a second angle, and correcting an error in the first scan based on the second scan; performing a global scan of a first area, a local scan of a second area within the first area, and correcting an error in the local scan based on the global scan; and performing a first scan at a first position at a first angle, a second scan at a substantially level region of a sample using the same scan angle, and correcting an error in the first scan based on the second scan.

In one embodiment, a method may comprise performing a first atomic force microscope (AFM) scan of a sample at a first position at a first angle to produce a first scan image, performing a second AFM scan of the sample at the first position at a second angle to produce a second scan image, and correcting a first error in the first scan image based on the second scan image to produce a corrected image output.

In another embodiment, an apparatus may comprise an atomic force microscopy (“AFM”) tool adapted to perform a first scan of a sample at a first position at a first angle, perform a second scan of the sample at the first position at a second angle, and correct a first error in the first scan based on the second scan.

In yet another embodiment, a method may comprise performing a first atomic force microscope (AFM) scan of a sample at a first position at a first angle to produce a first scan image, performing a second AFM scan of the sample at a second position offset from the first position at the first angle to produce a second scan image, wherein the second position is located within a portion of the sample that has a substantially level surface, and correcting a first error in the first scan image based on the second scan image.

In yet another embodiment, an apparatus may comprise an atomic force microscopy (“AFM”) tool adapted to perform a first scan of a sample at a first position at a first angle, performing a second scan of the sample at a second position offset from the first position at the first angle, wherein the second position comprises a flat reference point of the sample, and correcting a first error in the first scan based on the second scan.

In yet another embodiment, a method may comprise performing a global atomic force microscope (AFM) scan of a first selected area of a sample at a first position, the global AFM scan including a larger area of the sample than a local AFM scan, performing the local AFM scan of a second selected area of the sample at a second position, the second selected area including a smaller area within the first selected area, correcting a slope error in the local AFM scan based on the global AFM scan, and outputting a corrected sample image based on the global AFM scan, the local AFM scan, and the step of correcting.

In yet another embodiment, an apparatus may comprise an atomic force microscopy (“AFM”) tool adapted to perform a global scan of a sample at a first position, the global scan including a larger area of the sample than a local scan, perform the local scan at a second position, wherein the second position is within an area of the global scan and an area of the local scan is smaller than the area of the global scan, and correct a slope error in the local scan based on the global scan.

### DESCRIPTION OF DRAWINGS

FIGS. 1A through 1E are diagrams of an illustrative embodiment of a method for AFM scanning for obtaining a shape;

FIGS. 2A and 2B are diagrams of an another illustrative embodiment of a method for AFM scanning for obtaining a shape;

FIGS. 3A and 3B are diagrams of an another illustrative embodiment of a method for AFM scanning for obtaining a shape; and

FIG. 4 is a flow chart of another illustrative embodiment of a method for a AFM scanning for obtaining a shape.

### DETAILED DESCRIPTION

In the following detailed description of the embodiments, reference is made to the accompanying drawings which form a part hereof, and in which are shown by way of illustration of specific embodiments. It is to be understood that other embodiments may be utilized and changes may be made without departing from the scope of the present disclosure.

Scanning probe microscope techniques may be used for imaging and characterizing surface topology and properties at atomic resolution, such as for nanotechnology and nanoscience. Specifically, atomic force microscopy (“AFM”) (which is one type of scanning probe microscope techniques) can be used as a metrology tool in nanotechnology manufacturing, and specifically in nanoelectronic device manufacturing. AFM has applications to determine topography, shape, dimensions, locations of elements, and other potential uses, such as in semiconductors, photolithography and photomasks, and devices implementing thin film technologies, such as a transducer for magnetic data storage.

Manufacturing devices on a microscale or nanoscale can involve a series of complex fabrication process steps, such as by sequential layering on a substrate. To achieve a goal of high quality and low cost, the manufacturing process may include various metrology and inspection steps within a manufacturing line, such as to monitor density, pattern geometry, shape, dimensions, or topography. Further, calibrations to devices or systems, or to the manufacturing process itself, may be made based on the measurements or information received from the various metrology and inspection steps. The various metrology and inspection steps may often be on a micron or nanometer scale; for example, a transistor gate width may approximately be in a range of 32 nm to 35 nm. AFM may be used in semiconductor fabrication as a dimension metrology tool, such as for etching and chemical mechanical polishing characterization. Similar process technologies may be used in the photomask industries and thin film industries, as well as applications in biology and medical devices. For example, AFM allows a quick survey of a cross-sectional profile or surface topography to examine if a dimension is in specification, without destroying a product.

An atomic force microscope can scan a region of a sample that is highly localized and can be anywhere, as long as the space permits the tip size. With a feedback control loop, an atomic force microscope scanner can control a tiny probe to perform scanning motion in x (or y) and z directions to maintain a close proximity between the probe and sample surface, acquiring high-resolution positional data in all x, y, and z axes. A two or three dimensional topographic image can be constructed from the x/y/z spatial data. Then, offline software analysis can extract important geometric parameters about the measured target, such as depth, line width at top/middle/bottom locations, sidewall angle and profile shape, or surface topography.

In some implementations of AFM scanners, a tube scanner may be used to move a scanning tip or a sample. As a voltage is applied to a single outside electrode, a tube scanner will bend away from the electrode. This generates a horizontal motion in the x or y directions, which offers a capability to raster scan a sample surface. Such a design can cause scanner bow, a systematic shape error, while scanning a relatively large surface (such as >10 μm), in which a flat surface may be incorrectly measured as bowed, such as concave or otherwise curved. The bow error may sometimes be referred to as a run out error.

An AFM scanner may perform a scan comprising both an x-direction component and a y-direction component. The different scan components may be performed at different speeds. For example, an AFM scanner can collect topography information in the x direction with a relatively fast scan (such as around 1 second or less), while the y direction may be a relatively slow scan direction, and the topography may need to be constructed from many scan lines for a good quality image (such as around 256 seconds or even 512 seconds for a 256 or 512 pixel image). Scanning errors may show up in a final image caused by system drift in the slow scan direction.

In some examples, such as head media spacing (HMS) modeling for a data storage head, a trailing edge (TE) topography height can be measured using an air bearing surface (ABS) as a reference. Accurately measuring slider TE topography is important for HMS prediction, process control, modeling validation, and failure analysis. With the dimension of a transducer continually shrinking with each generation of devices, AFM tools have been used to measure the nanometer scale of TE topography. However, for a small feature, such as a perpendicular writer protrusion (PWP), a very small scan size must be used to clearly image such devices. Such images may be generally smaller than 4 μm, and the ABS feature is not included for use as a reference. If a localized feature, such as a contact pad, is used for image leveling, the localized feature shape can have a significant impact (e.g. can cause significant error) to the PWP image. As an example, a contact pad slope and shape can cause a significant error, such as to the PWP value, if the contact pad is used as a localized reference for leveling. Thus, the present disclosure presents an advanced AFM scanning method which can correct error caused by scanner bow, system drift, and localized feature shape, sometimes called slope error.

An advanced atomic force microscopy scanning method for obtaining the shape of a sample, sometimes referenced herein as the Advanced Pole tip recession (PTR) and Perpendicular writer protrusion (PWP) method (the combination of which may be referred to as the “APP method”), may be used to eliminate errors caused by scanner bow, system drift, and localized feature shape. While the method as described herein refers to PTR and PWP components of a magnetic data storage head, it should be understood that the systems and methods described may be applied to AFM in general and any type of sample.

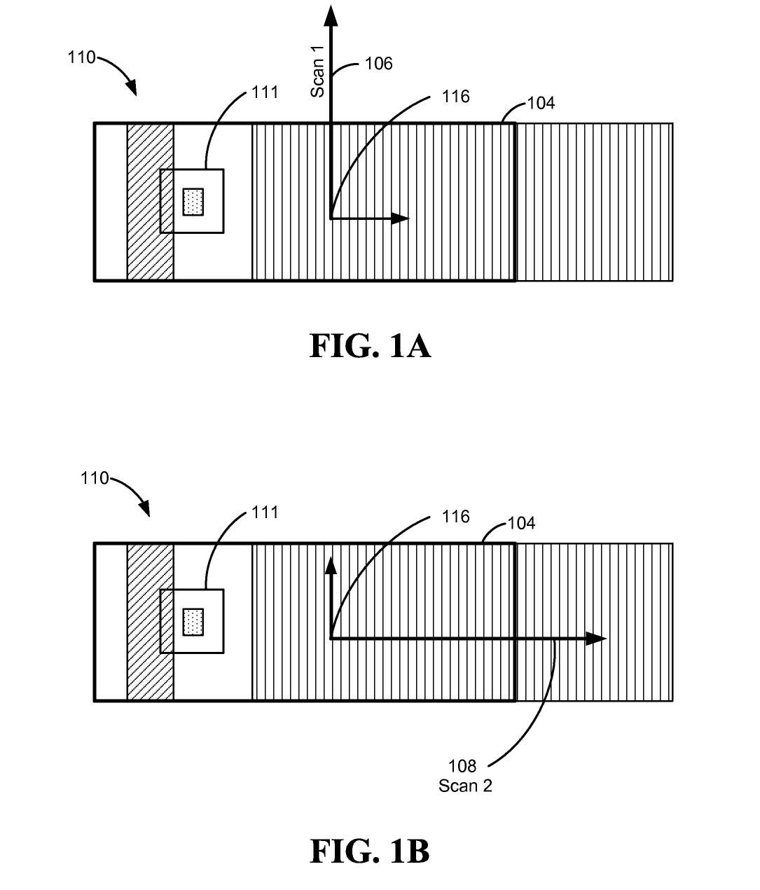

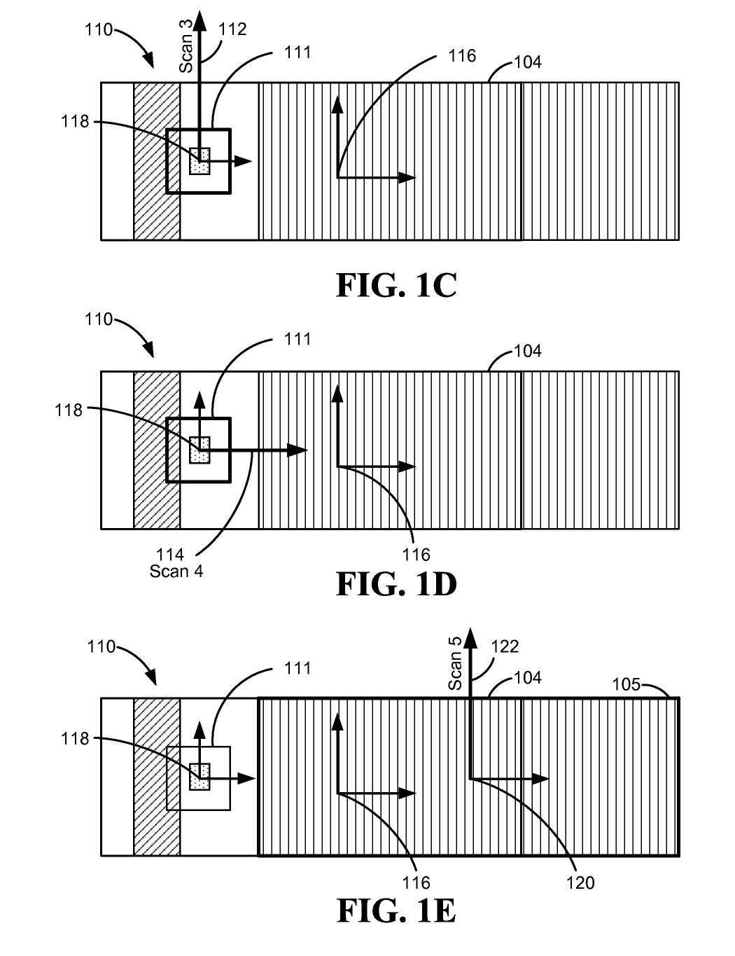

FIGS. 1A-1E depict a sequence of diagrams of an illustrative embodiment of a method for AFM scanning for obtaining a shape of a sample. The embodiment of the diagrams depicts a sample 110 to be scanned using the APP method. Specific regions 104, 105, and 111 of the sample may undergo AFM scans as part of the APP method. Scans performed according to the APP method may each comprise an x-direction scan and a y-direction scan as described above, with a fast scan direction and a slow scan direction. Example descriptions of scan orientation (such as 0 degrees or 90 degrees, or substantially perpendicular to previous scans) may refer to the orientation of the fast and slow scans. That is, a scan at a 0-degree orientation may comprise a fast scan at 0 degrees and accompanying slow scan at 90 degrees, while a scan at a 90-degree orientation may comprise a fast scan at 90 degrees and a slow scan at 0 degrees. In this manner, a 0-degree scan and a 90-degree scan may complement each other by switching the orientations of the fast and slow scans to correct errors in the fast or slow scan directions of each.

In addition, locations described with respect to scans, such as a coordinate (e.g. 0, 0) or offset, may refer to the starting point of a scan (e.g. starting at the coordinate and scanning in a given direction), or it may refer to how the AFM tool is centered with the area around the coordinate being scanned. Arrows depicting a direction of a scan in the accompanying drawings are to help conceptualize the orientation of a scan, but do not necessarily indicate that a scan begins at a given point and proceeds in the direction of the arrow.

Referring now to FIG. 1A, an AFM tool such as the tip or probe of an AFM scanner may be engaged at a first location 116, e.g. offset (0,0). The first location 116 may be within region 104, which may be referred to as the PTR scan zone or global scan zone. Region 104 may comprise the whole sample, or a subsection of the whole sample. In some embodiments, region 104 may also include region 111, with region 111 being a subset of region 104.

A first scan 106 may be performed using a 0 degree scan direction at the first location 116 to collect a first PTR image, as shown in FIG. 1A. A second scan 108 may be performed at a second angle, such as perpendicular to the first scan 106, at the first location 116 to collect a second image, as shown in FIG. 1B. In this example, the second scan 108 can be performed using a 90 degree scan direction relative to the first scan 106. The first scan 106 and the second scan 108 may scan region 104 as well as region 111, for example when region 111 is a subset of region 104.

The second image from the second scan 108 can be used to correct system drift errors in the first image. For example, because the fast-scanning direction of a given scan does not exhibit system drift errors, the fast-scan of the second image can be used to correct drift in the slow scan direction of the first image. The second image can be used to correct the slow scan direction drift in the first PTR image, such as by using a true 3D image flattening method. Such image flattening method may be performed, for example, by using instructions running on a computer-readable storage medium. The first scan 106 and the second scan 108 may be used to provide information on region 104, and in some embodiments, information on region 111 as well.

The AFM tool may be offset to a second location 118, which may be within region 111. Region 111, which may be referred to as the PWP scan zone or local scan zone, may be a subsection of the PTR scan zone 104, and may encompass an area or feature of the sample about which detailed information is desired or for which localized AFM scans are required. A third scan 112 may be performed using a 0 degree scan direction at the second location 118 to collect a third image, as shown in FIG. 1C. A fourth scan 114 may be performed perpendicular to the third scan 112 (i.e. using a 90 degree scan direction) from the second location 118 to collect a fourth image, as shown in FIG. 1D.

The fourth image can be used to correct slow scan direction drift in the third image, for example by using a true 3D image flattening method. The third scan 112 and the fourth scan 114 may be used to provide information on the local scan zone 111.

Turning now to FIG. 1E, the AFM tool may be disengaged and reset to the first location 116, and offset to a third location 120, by using an AFM step motor. The third location 120 should be a flat reference location on the sample 110. A fifth scan 122, which may be called a PTR reference scan, can be performed on the third location 120, as shown in FIG. 1E. The fifth scan 122 may be performed on a third region 105, which may be called the PTR reference scan zone. The PTR reference scan zone 105 may be the same size as the PTR scan zone 104. The fifth scan 122 can be used to correct the scanner bow in the first PTR image, for example by using image subtraction.

While the examples depicted in FIGS. 1A-1E describe individual scans for the first scan 106 through the fifth scan 122, it should be understood that in some embodiments one or more scans may be performed for each of the first through fifth scans. In some embodiments, different orientations for the scans may be used, or the scans may be performed in another order. Additional or fewer scans may be employed, such as for considerations of desired accuracy, speed, or efficiency.

Thus, the AFM scanning tool described herein corrects errors that may arise during AFM scanning The AFM scanning tool produces one or more images via AFM scanning of the surface of the sample. The images may be used to detect errors, manufacturing variances, or other features of the sample.

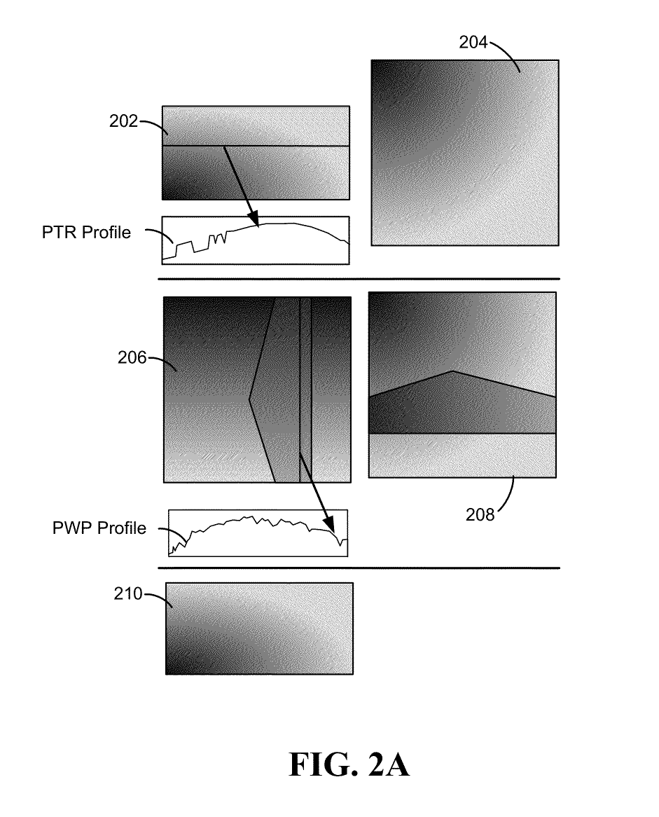

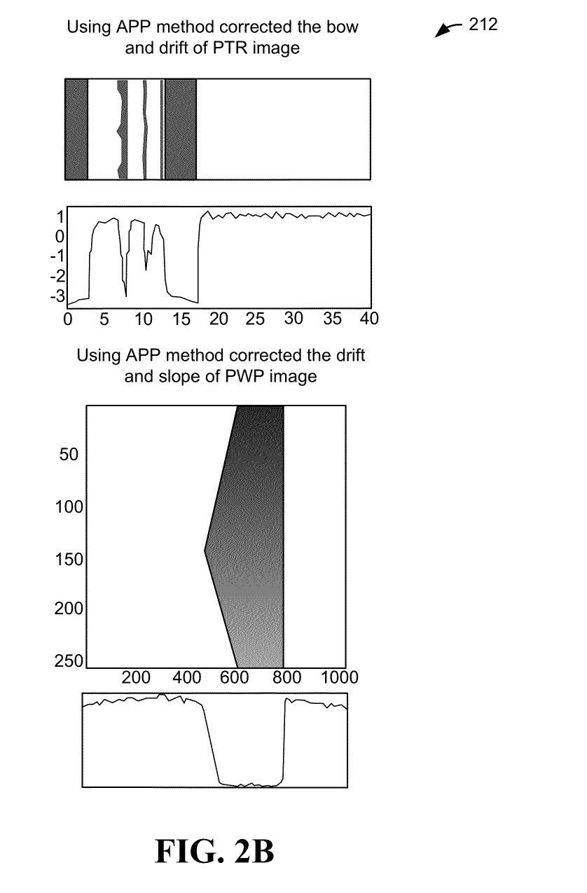

FIGS. 2A and 2B depict diagrams of an illustrative embodiment of a method for AFM scanning for obtaining a topography shape of a magnetic recording head sample. The images depicted in FIG. 2A correlate to embodiments of the scans performed as described for FIGS. 1A-1E, and indicate the correction of system drift and bow errors. The first image 202 depicts the first scan 106 performed from the first location 116 with a 0 degree scan direction as in FIG. 1A. The second image 204 depicts the second scan 108 performed from the first location 116 with a 90 degree scan direction as in FIG. 1B. The third image 206 depicts the third scan 112 performed from the second location 118 with a 0 degree scan direction as in FIG. 1C. The fourth image 208 depicts the fourth scan 114 performed from the second location 118 with a 90 degree scan direction as in FIG. 1D. The fifth image 210 depicts the fifth scan 122 performed as a reference scan on location 120 as in FIG. 1E.

The corrected PTR and PWP images that can reflect the true topography shape are displayed in the images 212 of FIG. 2B. Images 212 clearly show the drift and bow errors in the PTR scan have been eliminated, as well as the drift and slope errors in the PWP scan.

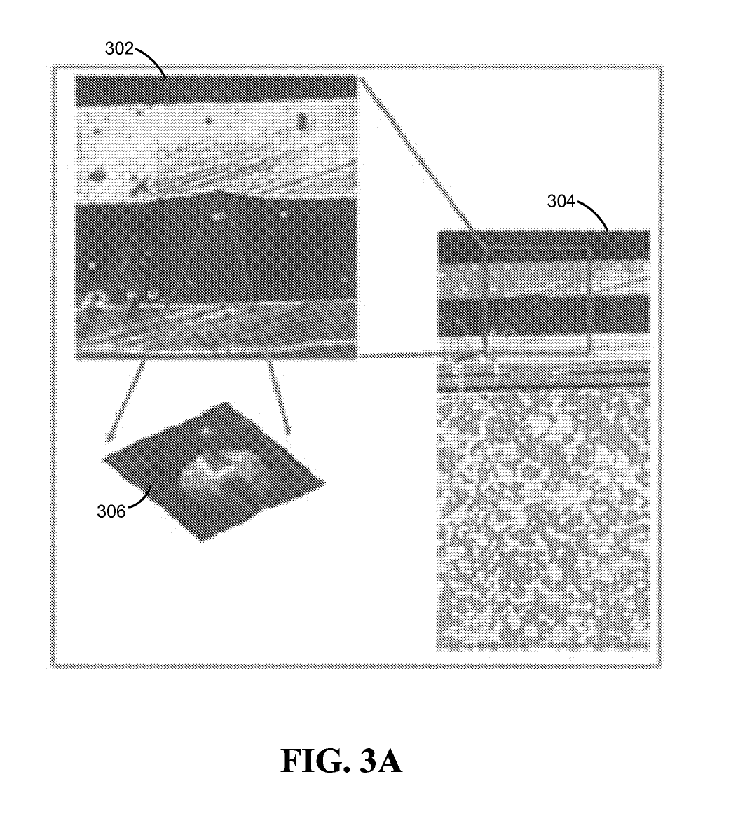

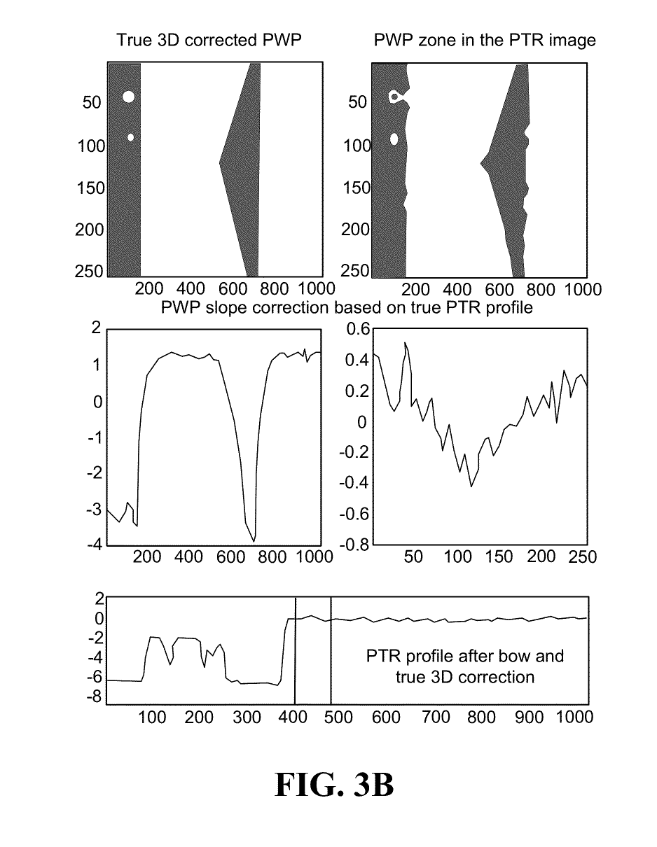

Turning now to FIGS. 3A and 3B, diagrams of an illustrative embodiment of an advanced AFM scanning method for obtaining a shape are depicted. Referring to FIG. 3A, pattern recognition, such as pattern recognition software or firmware, may be used to determine the PWP scan zone 306 inside the PTR scan zone 302 of the overall sample 304. Pattern recognition may provide a high degree of positional accuracy not otherwise available on AFM systems. In some embodiments, the PWP scan zone 306 may correspond to the region 111 in FIGS. 1A-1E, the PTR scan zone 302 may correspond to region 104, and the sample 304 may correspond to the whole sample 110 from FIGS. 1A-1E. The PWP scan zone 306 may be a subsection of the PTR scan zone 302. For example, the PWP scan zone 306 may be 4 μm out of a 40 μm PTR scan zone 304 (drawings may not be to scale). The scanned image of the PTR scan zone 302 may be leveled using a local reference within the PTR scan zone 304, such as an air-bearing surface (ABS) of a data storage head. Using the slope calculation of the PTR scan zone 302 obtained using a local reference, the slope of the PWP scan zone 306 within the PTR scan zone 302 can be calculated. Using this method, a slope of the PWP scan zone 306 can be determined even though a desired reference is not located within the PWP scan zone 306. Therefore a less desirable local feature such as a contact pad need not be used as a reference, thereby avoiding errors caused by the shape of the local feature. FIG. 3B shows the results of the PWP and PTR scans after corrections have been applied.

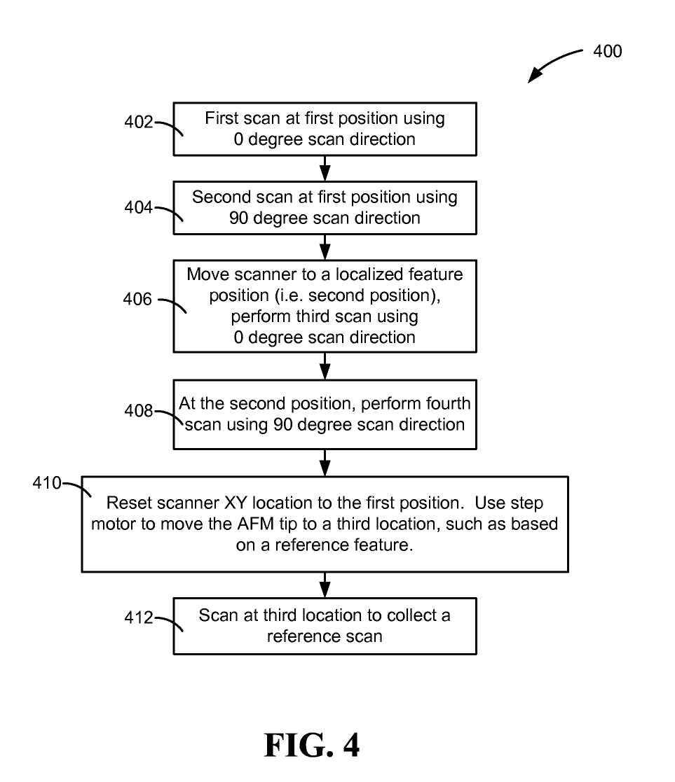

In an example, referring to FIG. 4, a method for an advanced AFM scanning method is shown and generally designated 400. The method 400 may be implemented on an AFM tool, whether it is a manual AFM tool or an automated AFM tool, and may include more steps or less steps than shown in FIG. 4.

At 402, a first scan may be performed in a 0 degree scan direction at a first position, such as the first scan 106 at first position 116 in FIG. 1A. At 404, a second scan may be performed in a 90 degree scan direction at the first position, such as the second scan 108 in FIG. 1B. The second scan, at 404, can be used to correct a slow scan direction drift from the first scan, such as by using a true 3D image flattening method.

At 406, a third scan may be performed in a 0 degree scan direction at a second position, such as the third scan 112 from the second position 118 in FIG. 1C. At 408, a fourth scan may be performed in a 90 degree scan direction at the second position, such as the fourth scan 114 in FIG. 1D. The fourth scan, at 408, may be used to correct a slow scan direction drift from the third scan, such as by using a true 3D image flattening method.

The AFM tool, such as a scanning tip, may be disengaged and reset to the X,Y location of the first position, at 410. Further, the AFM tool may be moved to a third location, such as by using a step motor of the AFM tool. The third location may be based on a reference point, such as third location 120 of FIG. 1E. A reference scan may be performed at the third location, at 412, to correct scanner bow in the first scan.

While the steps of method 400 describe scans in specific orientations and performed in a specific order, it is to be understood that these steps are used for illustration purposes only. More or fewer scans may be performed, in different orientations, and the scans may be performed in a different order than described in method 400.

In accordance with various embodiments, the methods and systems described herein may be implemented as one or more software programs, either on line or off line, and control algorithms running on a computer processor or controller. Further, a computer readable medium may store instructions, that when executed by a processor or computer system, cause a processor or computer system to perform the methods described herein. Dedicated hardware implementations including, but not limited to, application specific integrated circuits, programmable gate arrays, and other hardware devices can likewise be constructed to implement the methods described herein. The systems and methods described herein can be applied to any type of computer processing system that can perform the processes described herein. Further, the methods described herein may be implemented as a computer readable medium including instructions that when executed cause a processor to perform such methods.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown. Although a magnetic recording head has been used as an example of the proposed method, this disclosure can be applied to any other micro or nano scale device for topography and shape measurement.

What is claimed is:

1. A method comprising:
performing a first atomic force microscope (AFM) scan of a sample at a first position at a first angle to produce a first scan image;
performing a second AFM scan of the sample at the first position at a second angle to produce a second scan image; and
correcting a first error in the first scan image based on the second scan image to produce a corrected image output.

2. The method of claim 1, wherein the second angle is perpendicular to the first angle, and wherein the first error comprises inaccuracy caused by drift during the first AFM scan and wherein the first error is corrected using a true 3D image flattening procedure.

3. The method of claim 1 further comprising:
performing a reference AFM scan of the sample at a second position offset from the first position at the first angle to produce a third scan image, wherein the second position comprises a portion of the sample that has a substantially level surface; and
correcting a bowing error in the first scan image based on the third scan image using image subtraction.

4. The method of claim 3 further comprising:
performing a third AFM scan of the sample at a third position at a third angle to produce a fourth scan image, wherein the third position is within an area of the first AFM scan and an area of the third AFM scan is smaller than the area of the first AFM scan; and
correcting a slope error in the fourth scan image based on the first scan image.

5. The method of claim 4 further comprising:
performing a fourth AFM scan of the sample at the third position at a fourth angle perpendicular to the third angle to produce a fifth scan image; and
correcting a system drift error in the fourth scan image based on the fifth scan image.

6. An apparatus comprising:
an atomic force microscopy (“AFM”) tool adapted to:
perform a first scan of a sample at a first position at a first angle;
perform a second scan of the sample at the first position at a second angle; and
correct a first error in the first scan based on the second scan.

7. The apparatus of claim 6, wherein the AFM tool is further adapted to:
perform a reference scan of the sample at a second position offset from the first position at the first angle, wherein the second position comprises a portion of the sample that has a substantially level surface; and
correct a bowing error in the first scan based on the reference scan.

8. The apparatus of claim 7, wherein the AFM tool is further adapted to:
perform a third scan of the sample at a third position at a third angle, wherein the third position is within an area of the first scan and an area of the third scan is smaller than the area of the first scan; and;
correcting a slope error in the third scan based on the first scan.

9. The apparatus of claim 8, wherein the AFM tool is further adapted to:
perform a fourth scan of the sample at the third position at a fourth angle perpendicular to the third angle;
correcting a system drift error in the third scan based on the fourth scan; and
calculating a shape of the sample within the area of the third scan based on the third scan and the fourth scan.

10. A method comprising:
performing a first atomic force microscope (AFM) scan of a sample at a first position at a first angle to produce a first scan image;
performing a second AFM scan of the sample at a second position offset from the first position at the first angle to produce a second scan image, wherein the second position is located within a portion of the sample that has a substantially level surface; and
correcting a first error in the first scan image based on the second scan image.

11. The method of claim 10, further comprising:
performing a third AFM scan of the sample at the first position at a second angle perpendicular to the first angle to produce a third scan image; and
correcting a system drift error in the first scan image based on the third scan image.

12. The method of claim 11, wherein the first error includes a bowing error, and correcting the first error in the first scan image comprises using image subtraction based on the second scan image;
and wherein correcting the system drift error based on the third scan image comprises using a true 3D image flattening procedure.

13. The method of claim 11 further comprising:
performing a fourth AFM scan of the sample at a third position at a third angle to produce a fourth scan image, wherein the third position is within an area of the first AFM scan and an area of the fourth AFM scan is smaller than the area of the first AFM scan; and
correcting a slope error in the fourth scan image based on the first scan image.

14. The method of claim 13 further comprising:
performing a fifth AFM scan of the sample at the third position at a fourth angle perpendicular to the third angle to produce a fifth scan image; and
correcting a system drift error in the fourth scan image based on the fifth scan image.

15. An apparatus comprising:
an atomic force microscopy (“AFM”) tool adapted to:
perform a first scan of a sample at a first position at a first angle;
performing a second scan of the sample at a second position offset from the first position at the first angle, wherein the second position comprises a flat reference point of the sample; and
correcting a first error in the first scan based on the second scan.

16. The apparatus of claim 15, wherein the AFM tool is further adapted to:
perform a third scan of the sample at the first position at a second angle; and
correct a system drift error in the first scan based on the third scan.

17. The apparatus of claim 16, further comprising:
the first error includes a bowing error, and the AFM tool is adapted to correct the first error in the first scan using image subtraction based on the second scan;
the AFM tool is further adapted to correct the system drift error based on the third scan using a true 3D image subtraction procedure; and
the AFM tool produces a corrected image of the sample at a visual output.

18. The apparatus of claim 17, wherein the AFM tool is further adapted to:
perform a fourth scan of the sample at a third position at a third angle, wherein the third position is within an area of the first scan and an area of the fourth scan is smaller than the area of the first scan; and
correct a slope error in the fourth scan based on the first scan.

19. The apparatus of claim 18, wherein the AFM tool is further adapted to:
perform a fifth scan of the sample at the third position at a fourth angle perpendicular to the third angle; and
correcting a system drift error in the fourth scan based on the fifth scan.

20. A method comprising:
performing a global atomic force microscope (AFM) scan of a first selected area of a sample at a first position, the global AFM scan including a larger area of the sample than a local AFM scan;
performing the local AFM scan of a second selected area of the sample at a second position, the second selected area including a smaller area within the first selected area;
correcting a slope error in the local AFM scan based on the global AFM scan; and
outputting a corrected sample image based on the global AFM scan, the local AFM scan, and the step of correcting.

21. The method of claim 20 wherein performing the global AFM scan comprises:
performing a first global AFM scan of the sample at the first position at a first angle;
performing a second global AFM scan of the sample at the first position at a second angle perpendicular to the first angle; and
correcting a system drift error in the first global AFM scan based on the second global AFM scan.

22. The method of claim 21 further comprising:
performing a reference AFM scan of the sample at a third position offset from the first position at the first angle, wherein the third position comprises a portion of the sample that has a substantially level surface; and
correcting a run out error in the global AFM scan based on the reference AFM scan.

23. The method of claim 22 wherein performing the local AFM scan comprises:
performing a first local AFM scan of the sample at the second position at a third angle;
performing a second local AFM scan of the sample at the second position at a fourth angle perpendicular to the third angle of the first local AFM scan; and
correcting a system drift error in the first local AFM scan based on the second local AFM scan.

24. The method of claim 23 wherein
correcting the run out error in the global AFM scan based on the reference AFM scan comprises using image subtraction;
correcting the system drift error in the first global AFM scan based on the second global AFM scan and correcting the system drift error in the first local AFM scan based on the second local AFM scan comprises using a true 3D image flattening procedure; and
further comprising calculating a shape of the sample within the area of the local AFM scan based on the global AFM scan, the local AFM scan, and the correcting steps.

25. An apparatus comprising:
an atomic force microscopy (“AFM”) tool adapted to:
perform a global scan of a sample at a first position, the global scan including a larger area of the sample than a local scan;
perform the local scan at a second position, wherein the second position is within an area of the global scan and an area of the local scan is smaller than the area of the global scan; and
correct a slope error in the local scan based on the global scan.

26. The apparatus of claim 25, wherein the global scan comprises:
performing a first global scan of the sample at the first position at a first angle;
performing a second global scan of the sample at the first position at a second angle perpendicular to the first angle; and
correcting a system drift error in the first global scan based on the second global scan.

27. The apparatus of claim 26, wherein the AFM tool is further configured to:
perform a reference scan of the sample at a third position offset from the first position at the first angle, wherein the third position comprises a portion of the sample that has a substantially level surface; and
correct a run out error in the global scan based on the reference scan.

28. The apparatus of claim 27, wherein the local scan comprises:
performing a first local scan of the sample at the second position at a third angle;
performing a second local scan of the sample at the second position at a fourth angle perpendicular to the third angle of the first local scan; and
correcting a system drift error in the first local scan based on the second local scan using a true 3D image flattening procedure.

29. The apparatus of claim 28 wherein
correcting the run out error in the global scan based on the reference scan comprises using image subtraction; and
correcting the system drift error in the first global scan based on the second global scan and correcting the system drift error in the first local scan based on the second local scan comprises using a true 3D image flattening procedure.

30. The apparatus of claim 29, wherein the AFM tool is further adapted to:
calculate a shape of the sample within the area of the local scan based on the global scan, the local scan, and processes to correct the global scan and the local scan.
